(19) United States
(12) Patent Application Publication
(10) Pub. No.: US 2011/0174020 A1
(43) Pub. Date: Jul. 21, 2011

(54) OPTICAL FIBER MANUFACTURING METHOD

(75) Inventors: Yuta Aoki, Tokyo (JP); Kiyoshi Arima, Tokyo (JP); Junpei Watanabe, Tokyo (JP)

(73) Assignee: FURUKAWA ELECTRIC CO., LTD., Tokyo (JP)

(21) Appl. No.: 13/006,751

(22) Filed: Jan. 14, 2011

(30) Foreign Application Priority Data
Jan. 15, 2010 (JP) 2010-007479

(51) Int. Cl. C03B 37/07; C03B 37/025

(52) U.S. Cl. 65/381

(57) ABSTRACT

A method of manufacturing an optical fiber which comprises heating and melting one end of an optical fiber preform made of a glass, drawing a glass optical fiber from the one end, measuring a total volume of the drawn glass optical fiber, and carrying out a control of changing a drawing speed of the glass optical fiber on the basis of the measured total volume.

### CROSS-REFERENCE TO RELATED APPLICATIONS

This application is based upon and claims the benefit of priority from the prior Japanese Patent Applications No. 2010-007479, filed on Jan. 15, 2010; the entire contents of which are incorporated herein by reference.

### BACKGROUND OF THE DISCLOSURE

1. Field of the Disclosure

The present invention relates to a method of heating and melting one end of an optical fiber preform made of a glass and drawing a glass optical fiber from the one end.

2. Description of the Related Art

The optical fiber is manufactured by heating and melting one end of the optical fiber preform made of the glass by a drawing heating furnace, drawing the glass optical fiber from this one end and forming a coating made of a resin or the like on an outer periphery of the drawn glass optical fiber.

There is a case that a leading end portion of the optical fiber preform includes a defect portion in which a ratio between an outer diameter of a core portion and an outer diameter of a clad portion deflects from standard. Since the glass optical fiber which is drawn from the leading end portion as mentioned above is going to deflect from standard in its core diameter and clad diameter, it can not be used as a product. Accordingly, the glass optical fiber which is drawn from the defect portion should be disposed. In this case, the defect portion is effectively made good use in a tentative drawing for regulating various conditions for drawing, at a time of starting a manufacturing step of the optical fiber, thereby inhibiting a conforming article portion of the optical fiber preform from being used for the tentative drawing so as to be disposed.

Further, at a time of starting the manufacturing step of the optical fiber, a speed (drawing speed) for drawing the glass optical fiber is set to a low drawing speed at the beginning, and is accelerated at a certain time point so as to be set to a predetermined high drawing speed. The drawing speed is thereafter controlled constantly at the predetermined drawing speed, and the glass optical fiber coming to the product is manufactured. Conventionally, with regard to the control of the drawing speed mentioned above, there has been disclosed a method of carrying out a control of a feeding speed of the optical fiber preform and a drawing speed in association (cf. Japanese Patent Application Laid-open No. 2003-48738, for instance).

### BRIEF SUMMARY OF THE DISCLOSURE

In accordance with one aspect of the present disclosure, a method of manufacturing an optical fiber which comprises heating and melting one end of an optical fiber preform made of a glass, drawing a glass optical fiber from the one end, measuring a total volume of the drawn glass optical fiber, and carrying out a control of changing a drawing speed of the glass optical fiber on the basis of the measured total volume.

These and other objects, features, aspects, and advantages of the present disclosure will become apparent to those skilled in the art from the following detailed description, which, taken in conjunction with the annexed drawings, discloses preferred embodiments of the present disclosure.

### BRIEF DESCRIPTION OF THE DRAWINGS

FIG. 1 is a schematic view showing a whole structure of a manufacturing apparatus of an optical fiber which is used in an embodiment;

FIG. 2 is a schematic cross sectional view of an optical fiber preform shown in FIG. 1;

FIG. 3 is a view showing a timing chart of one example of a control of a drawing speed of a glass optical fiber, an outer diameter of the optical fiber and a feeding length of the optical fiber preform (a preform feeding length) in the embodiment; and

FIG. 4 is a view showing a change of a state of a leading end portion of the optical fiber preform.

### DESCRIPTION OF THE PREFERRED EMBODIMENTS

In the following, embodiments of a drawing method of optical fiber according to the present invention will be described in detail with reference to the accompanying drawings. However, the present invention is not limited to the embodiments. In the drawings, for the same or corresponding elements, the same reference numbers will be applied as necessary.

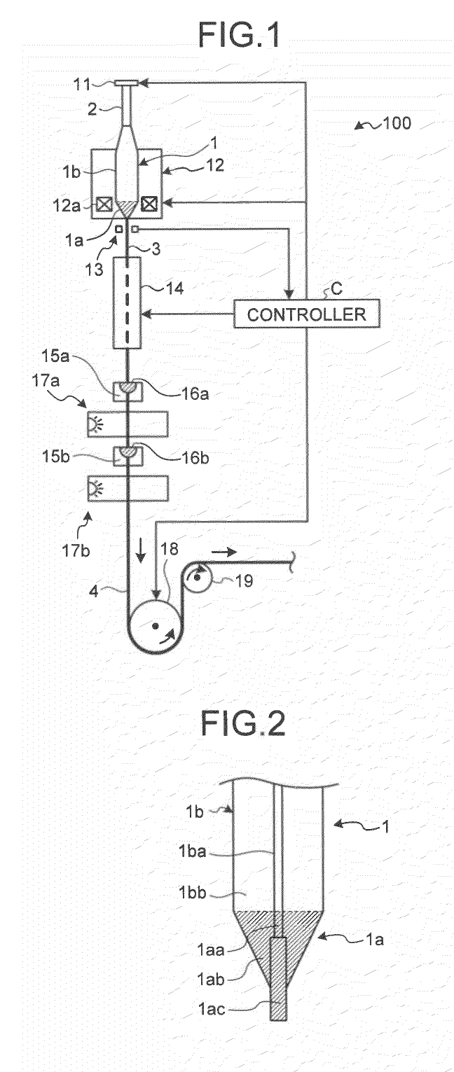

FIG. 1 is a schematic view showing a whole structure of a manufacturing apparatus of an optical fiber which is used in an embodiment in accordance with the present invention. As shown in FIG. 1, a manufacturing apparatus 100 of the optical fiber is provided with an elevating mechanism 11 which grips a glass support rod 2 deposited to an upper end of an optical fiber preform 1 and elevates the optical fiber preform 1, a drawing heating furnace 12 which has a heater 12a and is provided for heating and melting one end of the optical fiber preform 1, an outer diameter measuring device 13 which measures an outer diameter of a glass optical fiber 3 drawn from the optical fiber preform 1, a cooling tower 14 which can cool the glass optical fiber 3 by spraying an He gas or the like thereto, a primary die 15a which is arranged in a passage of the glass optical fiber 3, and coats a resin 16a for a primary coating, a secondary die 15b which coats an UV lamp irradiation chamber 17a and a resin 16b for a secondary coating, an UV lamp irradiation chamber 17b, a capstan roller 18 which serves as a pickup mechanism, and a guide roll 19. Further, the manufacturing apparatus 100 is provided with a controller C which is loaded a data of the outer diameter of the glass optical fiber 3 which the outer diameter measuring device 13 measures, and a data of a drawing speed of the glass optical fiber which is obtained from a rotating speed of the capstan roller 18, and controls the elevating mechanism 11, the drawing heating furnace 12, the cooling tower 14 and the capstan roller 18 on the basis of the data of the outer diameter and the drawing speed.

Next, a description will be given of the optical fiber preform 1 which is used in the present embodiment. The optical fiber preform 1 is made of a quartz glass, a diameter thereof is, for example, 100 mm, and a length thereof is, for example, 2000 mm, and it has a defect portion and a conforming article portion. FIG. 2 is a schematic cross sectional view of the optical fiber preform 1 shown in FIG. 1. As shown in FIG. 2, the optical fiber preform 1 has a defect portion 1a and a conforming article portion 1b. The conforming article portion 1b is constructed by a core portion 1ba and a clad portion 1bb. An outer diameter ratio between the core portion 1ba and the clad portion 1bb satisfies a desired standard. Accordingly, the glass optical fiber which is drawn from the conforming article portion 1b is structured such that the core diameter and the clad diameter satisfy the standards, and can be used in the optical fiber coming to the product. On the other hand, the defect portion 1a is positioned in a leading end portion of the optical fiber preform 1, and has the core portion 1aa and the clad portion 1ab, however, a dummy rod 1ac used at a time of manufacturing the optical fiber preform 1 exists in place of the core portion 1aa in the most leading end. Further, an outer diameter ratio between the core portion 1aa and the clad portion 1ab deflects from a desired standard. Therefore, since the glass optical fiber which is drawn from the defect portion 1a is going to deflect from the standard in its core diameter and clad diameter, or comes to the glass optical fiber with no core, it should be disposed.

A description will be given below of a drawing method of an optical fiber in accordance with the present embodiment with reference to FIG. 1. First of all, a volume W0 of the defect portion 1a of the optical fiber preform 1 is previously measured. The volume W0 can be determined by specifying a portion in which the outer diameter ratio between the core portion 1ba and the clad portion 1bb does not satisfy the standard, for example, by checking out a boundary between the dummy rod 1ac and the core portion 1aa by a visual observation or measuring the outer diameter of the optical fiber preform 1, and measuring a volume of the portion.

Next, the optical fiber preform 1 in which the support rod 2 is deposited to an upper end thereof is set to the drawing heating furnace 12, and the support rod 2 is gripped by the elevating mechanism 11. Next, the defect portion 1a in the leading end of the optical fiber preform 1 is heated and molten by the heater 12a while feeding the optical fiber preform 1 downward by the elevating mechanism 11, and the glass optical fiber is drawn. Next, the outer diameter measuring device 13 measures the outer diameter of the drawn glass optical fiber 3, and transmits the data to the controller C. Next, the glass optical fiber 3 is cooled by the cooling tower 14 as necessary. Next, the resin 16a is applied to the glass optical fiber 3 by the primary die 15a at a predetermined timing, and the primary coating is formed by curing the resin 16a by the UV lamp irradiation chamber 17a. Further, the resin 16b is applied to the outer periphery of the primary coating by the secondary die 15b, and the secondary coating is formed by curing the resin 16b by the UV lamp irradiation chamber 17b. At this time, during the while the defect portion 1a in the leading end of the optical fiber preform 1 is heated and molten so as to be drawn, the glass optical fiber 3 may be picked up by the capstan roller 18 and may be treated by a dedicated treatment apparatus without coating the resins 16a and 16b to the glass optical fiber 3. In this case, the application of the resins 16a and 16b to the glass optical fiber 3 is started thereafter at a predetermined timing, and the coating is formed. As a result, the optical fiber 4 in which the coating is formed is manufactured. The optical fiber 4 is picked up by the capstan roller 18, is guided by the guide roll 19, and is wound around the drum by a take-up mechanism (not shown).

The drawing step mentioned above is constructed by first, second and third drawing steps. The first drawing step is carried out in an early stage at a time of starting the drawing step, and carries out a regulation of various drawing conditions while drawing the glass optical fiber 3 at a comparatively lower first drawing speed, from the defect portion 1a. In the second drawing step, the drawing speed is accelerated from the first drawing speed to a second drawing speed. In the third drawing step, the drawing of the glass optical fiber 3 is carried out at the second drawing speed corresponding to a high speed at a time of manufacturing the optical fiber 4 coming to a product.

In the present embodiment, in the first drawing step, the glass optical fiber is drawn at the first drawing speed, and the lines speed of the glass optical fiber is accelerated from the first drawing speed to the second drawing speed at a time when the measured total volume of the glass optical fiber reaches the predetermined value by measuring the total volume of the drawn glass optical fiber. As mentioned above, the control of the drawing speed can be realized on the basis of the amount of the glass which is actually drawn so as to come to the glass optical fiber, by using the total volume of the drawn glass optical fiber directly for the control of the drawing speed.

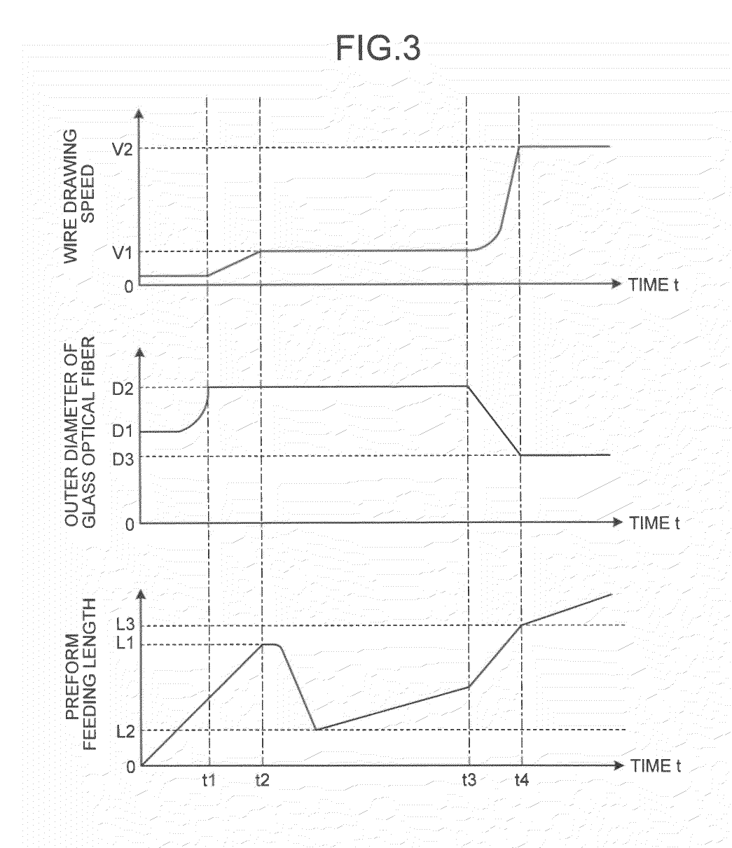

A description will be more specifically given below of the control of the drawing in the present embodiment with reference to FIG. 3. FIG. 3 is a view showing a timing chart of one example of the control of the drawing speed (the drawing speed) of the glass optical fiber, the outer diameter of the glass optical fiber, and the feeding length of the optical fiber preform (the preform feeding length) in the present embodiment. The timing chart in FIG. 3 is one example, and the present invention is not limited to this.

In this case, each of the controls mentioned above is carried out by the controller C. Specifically, the drawing speed is controlled by the controller C controlling a rotating speed of the capstan roller 18, the preform feeding length is controlled by the controller C controlling an amount of elevation of the elevating mechanism 11, and the outer diameter of the glass optical fiber 3 is controlled by the controller C controlling the elevating mechanism 11 and the capstan roller 18 on the basis of the data from the outer diameter measuring device 13. Further, the preform feeding length means a feeding length of the optical fiber preform to the below therefrom on the basis of a predetermined height position.

First of all, as the first drawing step, the drawing speed is accelerated from a hanging speed at a time 0 so as to be set to a first drawing speed V1 which is lower than a second drawing speed V2 at a time t2. In this case, the drawing speed is made constant at the hanging speed until the outer diameter of the glass optical fiber 3 is increased to D2. On the other hand, the preform feeding length is increased from zero at the time 0. On the other hand, the outer diameter of the glass optical fiber 3 is increased to an outer diameter D2 at a time t1 from the outer diameter D1 in the early stage. The outer diameter of the glass optical fiber 3 is increased as mentioned above for quickly consuming the defect portion 1a. In this case, in the present embodiment, the outer diameter is increased from the outer diameter D1 to the outer diameter D2, however, the outer diameter D1 and the outer diameter D2 may be equalized without being increased. In this case, the drawing speed is accelerated from the time 0, and the drawing speed V1 is maintained at a time when it reaches the drawing speed V1. Further, as a preferable value thereof, for example, the drawing speed V1 is between 300 and 1000 m/min, and the outer diameter D2 is between 100 and 500 μm. Further, the outer diameter D1 is a value which is equal to or less than the outer diameter D2.

Next, after the outer diameter of the glass optical fiber 3 reaches the outer diameter D2, the drawing speed is maintained at the drawing speed V1 as well as the outer diameter of the glass optical fiber 3 is maintained at the outer diameter D2. Further, the preform feeding length is controlled in such a manner that the outer diameter of the glass optical fiber 3 can be maintained at the outer diameter D2, however, the feeding length L2 is reduced to 35 mm after the feeding length L1 is increased to 150 mm, and is thereafter increased little by little from the feeding length L2, in the present embodiment. As mentioned above, if the feeding length is temporarily increased so as to increase a melding amount of the defect portion 1a of the optical fiber preform 1 at a time of increasing the outer diameter of the glass optical fiber 3 and thereafter maintaining constant, and is thereafter reduced to an appropriate feeding length, it is possible to rapidly draw the defect portion 1a for a short time so as to consume, and the supply amount of the optical fiber preform 1 to the drawing heating furnace 12 is adjusted. Accordingly, this structure is preferable.

Here, in the present embodiment, the total volume of the drawn glass optical fiber 3 is measured on the basis of the drawing speed and the outer diameter of the drawn glass optical fiber 3 in the controller C. Specifically, on the assumption that a drawing speed of the glass optical fiber 3 at a certain time is set to V [m/min], an outer diameter is set to D [μm], and a volume of the glass optical fiber 3 drawn per one second at the time is set to δW, the value δW can be determined in accordance with the following expression (1).

δW=πD²/4×V/60×10⁶ [μm³/S] (1)

Accordingly, it is possible to measure the total volume of the drawn glass optical fiber 3 by accumulating the value δW in the expression (1) from the drawing start time.

Next, if the total volume of the drawn glass optical fiber 3 reaches a predetermined volume W1 at the time t3, the controller C increases the preform feeding length to the feeding length L3 as well as accelerating the drawing speed from the drawing speed V1 to the drawing speed V2, as the second drawing step. On the other hand, it reduces the outer diameter of the glass optical fiber 3 from the outer diameter D2 to the outer diameter D3. Here, in the case that the outer diameter D2 and the outer diameter D3 are equal, the outer diameter is not reduced.

Thereafter, if the drawing speed reaches the drawing speed V2 at a time t4, the controller C maintains the drawing speed at the drawing speed V2, increases the preform feeding length from the feeding length L3, maintains the outer diameter of the glass optical fiber 3 at the outer diameter D3, draws the glass optical fiber 3, and manufactures the optical fiber 4 coming to the product, as the third drawing step. In this case, the drawing speed V2 is, for example, 1000 to 2000 m/min, the outer diameter D3 is, for example, 80 to 130 μm (in this case, being equal to or less than the outer diameter D2), and the feeding length L3 is, for example, 200 mm.

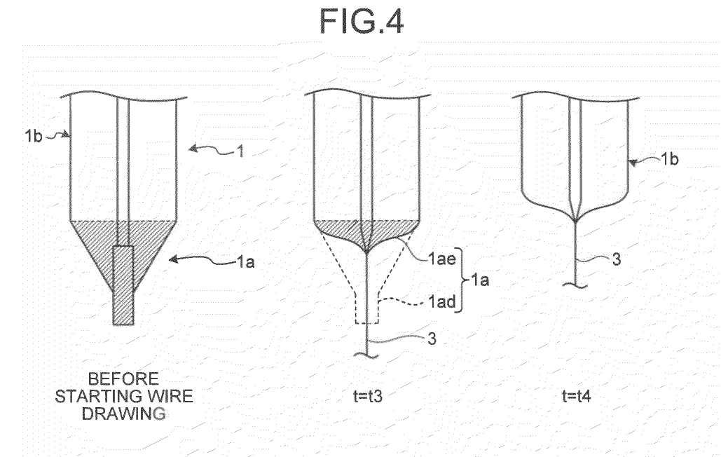

Here, FIG. 4 is a view showing a change of a state of the leading end portion of the optical fiber preform 1. As shown in FIG. 4, the leading end portion of the optical fiber preform 1 at the time t3 comes to such a state that the portion lad of the volume W1 is drawn so as to come to the glass optical fiber 3 in the defect portion 1a, and the portion 1ae is left. While the drawing is carried out while accelerating the drawing speed in the second drawing step from this state, the left portion 1ae is drawn. As a result, since all the defect portion 1a is consumed at a time t4 when the drawing speed reaches the drawing speed V2, the glass optical fiber 3 satisfying the desired standard is drawn without wasting the glass material, at the desired drawing speed V2 from the conforming portion 1b, and the optical fiber 4 coming to the product can be manufactured.

In this case, the total volume W1 of the drawn glass optical fiber 3 at a time of starting the acceleration of the drawing speed can be set, for example, as an expression W1=W0−W2, on the basis of the volume W0 of the defect portion 1a of the optical fiber preform 1, and the total volume W2 of the glass optical fiber 3 which can be drawn in the second drawing step. The total volume W2 [μm³] of the glass optical fiber 3 which can be drawn in this second drawing step can be determined by the following expression (2) by using the drawing speeds V1 and V2 [μm/min], a time (t4−t3) accelerating the drawing speed [s], and the outer diameters D2 and D3 [μm] of the glass optical fiber 3. In this case, it is assumed that the acceleration of the drawing speed is carried out at a uniform acceleration, and a relationship D2=D3 is established.

W2=π×(D2)²/4×(V2+V1)/2×10⁶×(t4−t3) [μm³] (2)

For example, on the assumption of V1=70 m/min, V2=1200 m/min, D2=125 μm, and (t4−t3)=60 min, the value W2 is 467.6×10¹² μm³.

As described above, in accordance with the present embodiment, it is possible to appropriately carry out the control of the drawing speed in such a manner that the waste of the glass material can be prevented in the drawing of the glass optical fiber 3.

In this case, in the embodiment mentioned above, the total volume of the drawn glass optical fiber is measured on the basis of the drawing speed and the outer diameter of the glass optical fiber, however, the total volume of the drawn glass optical fiber may be measured on the basis of a reducing amount of a mass of the optical fiber preform in accordance with the other embodiment of the present invention. In other words, the reducing amount of the mass of the optical fiber preform is assumed to correspond to the mass of the drawn glass optical fiber, and the total volume of the glass optical fiber may be measured on the basis thereof. In order to execute the other embodiment mentioned above, the elevating mechanism of the optical fiber preform may be provided, for example, a load cell for measuring the mass of the optical fiber preform.

Further, in the embodiment, in the case that the coating is not formed with respect to the glass optical fiber which is drawn from the defect portion of the optical fiber preform, the glass optical fiber tends to be broken off very easily, and it is broken off only by bending a little particularly in accordance that the outer diameter becomes thicker. Therefore, it is preferable to make the outer diameter of the glass optical fiber equal to or less than 300 μm. Further, the thicker the glass optical fiber is, the greater an amount of heat thereof is. Accordingly, in the case that the glass optical fiber directly comes into contact with a rubber member such as the capstan roller or the guide roll, it is preferable to cool the glass optical fiber in such a manner that a temperature thereof becomes equal to or lower than 100° C., preferably equal to lower than 50° C., thereby preventing the rubber member from being broken by the heat of the glass optical fiber.

Further, in the embodiment mentioned above, the first drawing speed is the constant value, however, it is not necessary to be constant. For example, in the case that the step of reducing the outer diameter D2 of the glass optical fiber to the outer diameter D3 is carried out by the first drawing step, the drawing speed may be changed in correspondence to the change of the outer diameter. In this case, it is preferable to carry out the control of changing the drawing speed at this time on the basis of the total volume of the drawn glass optical fiber.

Further, the embodiment mentioned above is structured such that the drawing speed is accelerated at a time when the total volume of the drawn glass optical fiber reaches the predetermined value, however, the present invention is not limited to this. In other words, the control of the drawing speed can be carried out more appropriately than the conventional one, as far as the control of changing the drawing speed is carried out on the basis of the total volume of the drawn glass optical fiber.

Further, in the embodiment mentioned above, there is shown the case that the defect portion exists in the leading end portion of the optical fiber preform, however, the present invention can be applied also to a case that the portion to be treated such as the defect portion or the like exists at the other positions than the leading end portion and the glass optical fiber is drawn from one end thereof.

As described above, in accordance with the embodiment of the present invention, since the control of changing the line speed of the glass optical fiber is carried out on the basis of a total volume of the glass optical fiber which is drawn, there can be obtained such an effect that a waste or the like of the glass material is prevented, and it is possible to appropriately carry out the control of the line speed.

Additional advantages and modifications will readily occur to those skilled in the art. Therefore, the disclosure in its broader aspects is not limited to the specific details, representative embodiments and alternate examples shown and described herein. Accordingly, various modifications may be made without departing from the spirit or scope of the general inventive concept as defined by the appended claims and their equivalents. Furthermore, the above-mentioned embodiments and the alternate examples can be arbitrarily combined with one another.

What is claimed is:

1. A method of manufacturing an optical fiber, comprising:
heating and melting one end of an optical fiber preform made of a glass,
drawing a glass optical fiber from the one end,
measuring a total volume of the drawn glass optical fiber; and
carrying out a control of changing a drawing speed of the glass optical fiber on the basis of the measured total volume.

2. The method according to claim 1, wherein the drawing of the glass optical fiber comprises the steps of:
a first drawing step of drawing the glass optical fiber at a first drawing speed; and
a second drawing step of accelerating the drawing speed of the glass optical fiber from the first drawing speed to a second drawing speed at a time when the measured total volume reaches a predetermined value.

3. The method according to claim 2, wherein the predetermined value is set on the basis of a volume of a defect portion to be disposed in one end of the optical fiber preform, and a total volume of the glass optical fiber which is drawn in the second drawing step.

4. The method according to claim 1, wherein the total volume is measured on the basis of a drawing speed and an outer diameter of the glass optical fiber.

5. The method according to claim 1, wherein the total volume is measured on the basis of a reducing amount of a mass of the optical fiber preform.

6. The method according to claim 2, further comprising a third drawing step of drawing the glass optical fiber coming to a product at the second drawing speed, after the second drawing step.

7. The method according to claim 2, wherein a feeding length of the optical fiber preform is reduced after the feeding length is temporarily increased, in the first drawing step.
